(19) United States
(12) Patent Application Publication
(10) Pub. No.: US 2026/0021853 A1
(43) Pub. Date: Jan. 22, 2026

(54) TRACK-PROPELLED VEHICLE

(71) Applicant: EXMARK MANUFACTURING COMPANY INCORPORATED, Beatrice, NE (US)

(72) Inventors: Nickolas T. Moore, Beatrice, NE (US); Timothy D. Andre, Firth, NE (US)

(21) Appl. No.: 19/270,909

(22) Filed: Jul. 16, 2025

Related U.S. Application Data
(60) Provisional application No. 63/672,811, filed on Jul. 18, 2024.

(51) Int. Cl. B62D 55/02; A01B 45/02; B62D 55/10; B62D 55/12

(52) U.S. Cl. CPC B62D 55/02; B62D 55/10; B62D 55/12; A01B 45/02

(57) ABSTRACT

Some aspects of the present technology relate to a vehicle having a chassis and a track assembly. A drive sprocket is rotatable relative to the chassis, a driven sprocket rotatable relative to the chassis, and a track is disposed around the drive sprocket and the driven sprocket. The track is in mechanical communication with the drive sprocket and the driven sprocket and the track is configured to contact a ground surface. An implement is coupled to the chassis. A mechanical communication assembly is in operative communication with the implement, where the mechanical communication assembly extends from the driven sprocket to the implement.

The present application claims the benefit of U.S. Provisional Application No. 63/672,811, filed on 18 Jul. 2024, which is incorporated by reference herein.

### TECHNOLOGICAL FIELD

The present disclosure is generally related to a vehicle. More particularly, the present disclosure is related to track-propelled vehicle.

### SUMMARY

Some aspects of the technology disclosed herein relate to a grounds maintenance vehicle having a chassis and a track assembly. The track assembly has a drive sprocket rotatable relative to the chassis a driven sprocket rotatable relative to the chassis. A track is disposed around the drive sprocket and the driven sprocket. The track is in mechanical communication with the drive sprocket and the driven sprocket and the track is configured to contact a ground surface. An implement is coupled to the chassis. A mechanical communication assembly is in operative communication with the implement, where the mechanical communication assembly extends from the driven sprocket to the implement.

According to some such aspects, the mechanical communication assembly includes a belt. Additionally or alternatively, the mechanical communication assembly includes a gear box. Additionally or alternatively, the mechanical communication assembly comprises a chain drive. Additionally or alternatively, the implement includes aerating tines coupled to the chassis. Additionally or alternatively, the implement has a lateral line of action.

Additionally or alternatively, the track has a ground-contact section extending longitudinally, and the lateral line of action is central to the ground-contact section in the longitudinal direction. Additionally or alternatively, the lateral line of action of the implement is repositionable and has repositioning range, where the lateral line of action of the implement is central to the ground-contact section in the longitudinal direction through the repositioning range. Additionally or alternatively, the lateral line of action is a lateral pivot axis and the repositioning range is a pivot range about the lateral pivot axis.

Additionally or alternatively, the vehicle has a first bogey wheel rotatable relative to the chassis and a second bogey wheel rotatable relative to the chassis, where the first bogey wheel and the second bogey wheel are longitudinally spaced, and the track is further disposed around the first bogey wheel and the second bogey wheel. Additionally or alternatively, the vehicle has a tensioner bar having a mounting surface. A first end extends longitudinally outward from the mounting surface, and a second end extends longitudinally outward from the mounting surface. The first end and the second end are longitudinally translatable relative to the mounting surface. The mounting surface is fixed to the chassis, the first bogey wheel is rotatably coupled to the first end and the second bogey wheel is rotatably coupled to the second end.

Additionally or alternatively, the first bogey wheel and the second bogey wheel are aligned in the vertical direction. Additionally or alternatively, the track has a ground-contact section extending longitudinally from the first bogey wheel to the second bogey wheel. Additionally or alternatively, the first end and the second end of the tensioner bar are not vertically or laterally translatable relative to the chassis. Additionally or alternatively, tensioner bar includes an adjustment interface in communication with the first end and the second end, where the adjustment interface is configured to translate the first end and the second end equally in opposite longitudinal directions.

Additionally or alternatively, the adjustment interface is rotatable relative to the mounting surface. Additionally or alternatively, the vehicle has a third bogey wheel rotatably fixed to the chassis. The third bogey wheel is central to the first bogey wheel and the second bogey wheel, and the first bogey wheel and second bogey wheel are equally spaced from the third bogey wheel. Additionally or alternatively, the first bogey wheel, the second bogey wheel, and the third bogey wheel define a horizontal plane that the track extends across.

Some aspects of the present technology relate to a grounds maintenance vehicle having a chassis, a track assembly, and an implement coupled to the chassis. The track assembly has a drive sprocket rotatable relative to the chassis, a first bogey wheel rotatable relative to the chassis, and a track disposed around the drive sprocket and the first bogey wheel. The track is in mechanical communication with the drive sprocket and the first bogey wheel and the track has a ground-contact section extending longitudinally. The implement has a lateral line of action that is central to the ground-contact section in the longitudinal direction.

According to some such aspects, the lateral line of action of the implement is repositionable and has a repositioning range, where the lateral line of action of the implement is central to the ground-contact section in the longitudinal direction through the repositioning range. Additionally or alternatively, the vehicle has a driven sprocket rotatable relative to the chassis, where the track is in mechanical communication with the driven sprocket. Additionally or alternatively, the lateral line of action is a lateral pivot axis and the repositioning range is a pivot range about the lateral pivot axis. Additionally or alternatively, the driven sprocket has a driven sprocket rotational axis, where the lateral pivot axis and the driven sprocket rotational axis are collinear.

Additionally or alternatively, the vehicle has a mechanical communication assembly in operative communication with the implement, where the mechanical communication assembly extends from the driven sprocket to the implement. Additionally or alternatively, the mechanical communication assembly includes a gear box. Additionally or alternatively, the mechanical communication assembly includes a timing belt. Additionally or alternatively, the mechanical communication assembly includes a chain drive. Additionally or alternatively, the implement includes aerating tines.

Additionally or alternatively, the vehicle has a second bogey wheel rotatable relative to the chassis, where the first bogey wheel and the second bogey wheel are longitudinally spaced and the track is further disposed around the second bogey wheel. Additionally or alternatively, the ground-contact section is defined from the first bogey wheel to the second bogey wheel. Additionally or alternatively, the vehicle has a tensioner bar having a mounting surface, a first end extending longitudinally outward from the mounting surface, and a second end extending longitudinally outward from the mounting surface, wherein the first end and the second end are longitudinally translatable relative to the mounting surface, the mounting surface is fixed to the chassis, the first bogey wheel is rotatably coupled to the first end and the second bogey wheel is rotatably coupled to the second end.

Additionally or alternatively, the first bogey wheel and the second bogey wheel are aligned in the vertical direction. Additionally or alternatively, the first end and the second end of the tensioner bar are not vertically or laterally translatable relative to the chassis. Additionally or alternatively, the tensioner bar comprises an adjustment interface in communication with the first end and the second end, where the adjustment interface is configured to translate the first end and the second end equally in opposite longitudinal directions.

Additionally or alternatively, the adjustment interface is rotatable relative to the mounting surface. Additionally or alternatively, the vehicle has a third bogey wheel rotatably fixed to the chassis. The third bogey wheel is central to the first bogey wheel and the second bogey wheel, and the first bogey wheel and second bogey wheel are equally spaced from the third bogey wheel. Additionally or alternatively, the first bogey wheel, the second bogey wheel, and the third bogey wheel define a horizontal plane that the track extends across.

Some aspects of the present technology relate to a grounds maintenance vehicle having a chassis and a ground-contacting track assembly disposed between a ground surface and the chassis. The ground-contacting track assembly has a drive sprocket rotatable relative to the chassis, a first bogey wheel rotatable relative to the chassis, and a second bogey wheel rotatable relative to the chassis. The first bogey wheel and the second bogey wheel are longitudinally spaced. A track is disposed around the drive sprocket, the first bogey wheel, and the second bogey wheel. A tensioner bar has a mounting surface, a first end extending longitudinally outward from the mounting surface, and a second end extending longitudinally outward from the mounting surface. The first end and the second end are longitudinally translatable relative to the mounting surface. The mounting surface is fixed to the chassis, the first bogey wheel is rotatably coupled to the first end, and the second bogey wheel is rotatably coupled to the second end.

According to some such aspects, the first bogey wheel and the second bogey wheel are aligned in the vertical direction. Additionally or alternatively, a driven sprocket is rotatable relative to the chassis, where the track is disposed around the driven sprocket. Additionally or alternatively, the track has a ground-contact section extending longitudinally from the first bogey wheel to the second bogey wheel. Additionally or alternatively, the first end and the second end of the tensioner bar are not vertically or laterally translatable relative to the chassis.

Additionally or alternatively, the tensioner bar includes an adjustment interface in communication with the first end and the second end, wherein the adjustment interface is configured to translate the first end and the second end equally in opposite longitudinal directions. Additionally or alternatively, the adjustment interface is rotatable relative to the mounting surface. Additionally or alternatively, the vehicle has a third bogey wheel rotatably fixed to the chassis. The third bogey wheel is central to the first bogey wheel and the second bogey wheel and the first bogey wheel and second bogey wheel are equally spaced from the third bogey wheel. Additionally or alternatively, the first bogey wheel, the second bogey wheel, and the third bogey wheel define a horizontal plane that the track extends across.

Additionally or alternatively, the vehicle has an implement rotatably coupled to the chassis. Additionally or alternatively, the track has a ground-contact section, and the implement has a lateral line of action that is central to the ground-contact section in the longitudinal direction. Additionally or alternatively, the lateral line of action of the implement is repositionable and has a repositioning range. The lateral line of axis of the implement is central to the ground-contact section in the longitudinal direction through the repositioning range. Additionally or alternatively, the lateral line of action is a lateral pivot axis and the repositioning range is a pivot range about the lateral pivot axis. Additionally or alternatively, the vehicle has a driven sprocket rotatable relative to the chassis, where the track is in mechanical communication with the driven sprocket. A mechanical communication assembly in operative communication with the implement, where the mechanical communication assembly extends from the driven sprocket to the implement.

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF THE DRAWINGS

The present technology may be more completely understood and appreciated in consideration of the following detailed description of various embodiments in connection with the accompanying drawings.

FIG. 1 is a first perspective view of an example vehicle consistent with the technology disclosed herein. FIG. 2 is a second perspective view of the example vehicle of FIG. 1.

FIG. 3 is a side view of the example vehicle of FIG. 1.

FIG. 4 is a partial perspective view of an example vehicle consistent with FIGS. 1-3.

FIG. 5 is a partial side vie of an example vehicle consistent with FIGS. 1-4.

FIG. 6 is a cross-sectional view of an example vehicle consistent with FIGS. 1-4.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the description and claims are to be understood as being modified in all instances by the term “about.”

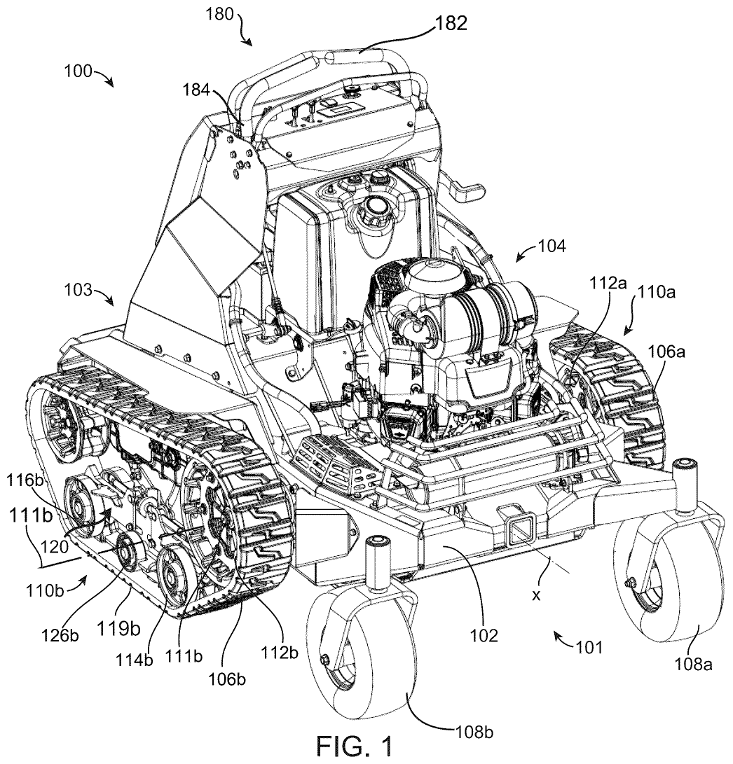

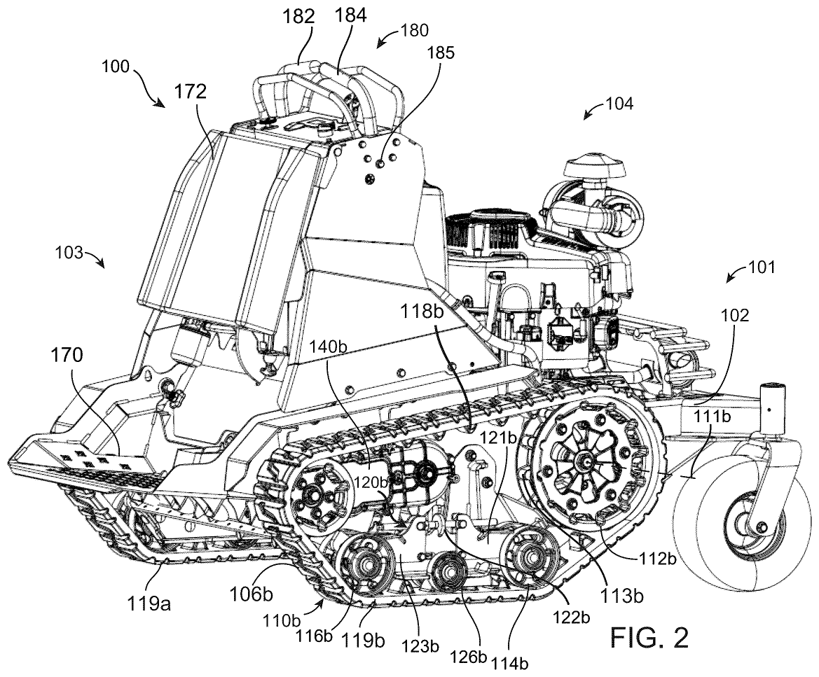

With reference to the figures of the drawing, wherein like reference numerals designate like parts and assemblies throughout the several views, FIGS. 1-3 illustrate an example vehicle 100 that is track-propelled. As shown in this view, the vehicle 100 may be configured as a dedicated, self-propelled, ride-on (e.g., stand-on) and/or walk-behind vehicle. While described with reference to a maintenance vehicle such as an aerator (also referred to herein simply as “vehicle”), those of skill in the art will realize that the concepts described herein are equally applicable to other types of walk-behind, ride-behind, ride in, or ride-on self-propelled vehicles including multi-purpose vehicles. Maintenance vehicles other than aerators are further contemplated such as plows, tillers, slicer-seeders, and de-thatchers.

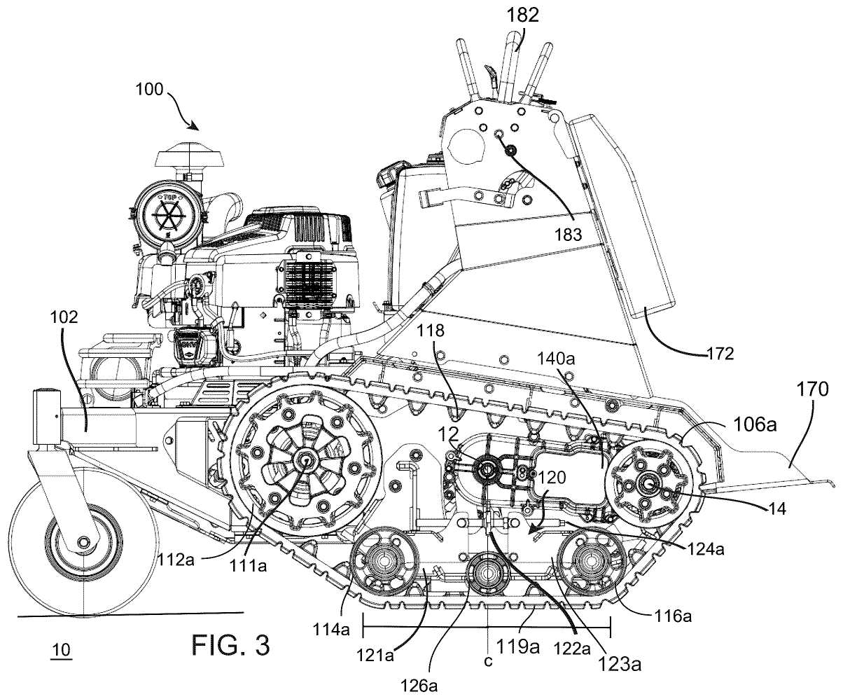

It is noted that the terms “comprises” and variations thereof do not have a limiting meaning where these terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the vehicle 100 while the vehicle is in an operating configuration, e.g., while the vehicle 100 is positioned such that the track 106 rests upon a ground surface 10 as shown in FIG. 3. These terms are used only to simplify the description, however, and not to limit the interpretation of any embodiment described.

Still further, the suffixes “a” and “b” may be used throughout this description to denote various left-and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

Now with reference to FIGS. 1-3, the vehicle 100 generally includes a chassis 102 and a ground-contacting track assembly 110. The chassis 102 is generally configured to provide a structural framework for the vehicle 100. The chassis 102 may support a power source or prime mover 104, e.g., electric motor or internal combustion engine and various other components of the vehicle 100, which will be described. The vehicle 100 generally has a first end 101 and a second end 103, where in the current example the second end 103 is the rearward end and the first end 101 is a front end. A longitudinal axis x (FIG. 1) extends between the front and rear ends where the axis x is parallel to a direction of vehicle travel when the vehicle is traveling in a straight line. The prime mover 104 is generally configured to be controlled by a user through a control station 180, for example. The control station 180 is in operative communication with the prime mover 104. The control station 180 can have one or more handles 182, 184 that are configured to selectively propel and direct vehicle propulsion.

The track assembly 110 is generally configured to propel the vehicle 100, including the chassis 102, across the ground surface 10. The track assembly 110 is ground-contacting and has a ground-contact section 119 that makes direct contact with the ground. In the current example, the vehicle 100 has a pair of laterally opposed track assemblies 110a, 110b coupled to opposite (left and right) sides of the chassis 102 to support the vehicle 100 upon, and propel the vehicle 100 over, the ground surface 10.

The track assembly 110 generally has a drive sprocket 112 in operative communication with a track 106. In some such embodiments, the track assembly 110 also has a first bogey wheel 114, a second bogey wheel 116, and a tensioner bar 120. The track 106 is generally disposed around the first bogey wheel 114, the second bogey wheel 116, and the drive sprocket 112 and is configured to rotate around the drive sprocket 112 and the bogey wheels 114, 116 to propel the vehicle 100. The track 106 forms a closed loop around the drive sprocket 112 and the bogey wheels 116.

The drive sprocket 112 is rotatable relative to the chassis 102 and is configured to transmit motive force to the track 106. The drive sprocket 112 can have a drive sprocket rotational axis 111 about which the drive sprocket 112 is configured to rotate. In various embodiments, the drive sprocket 112 and the track 106 are configured to mutually engage to facilitate force transmission from the drive sprocket 112 to the track 106. In one particular example, as best visible in FIG. 2, the track 106 defines teeth 118 that are configured to be engaged by corresponding lugs 113 defined by the drive sprocket 112. Alternate configurations are certainly contemplated, however.

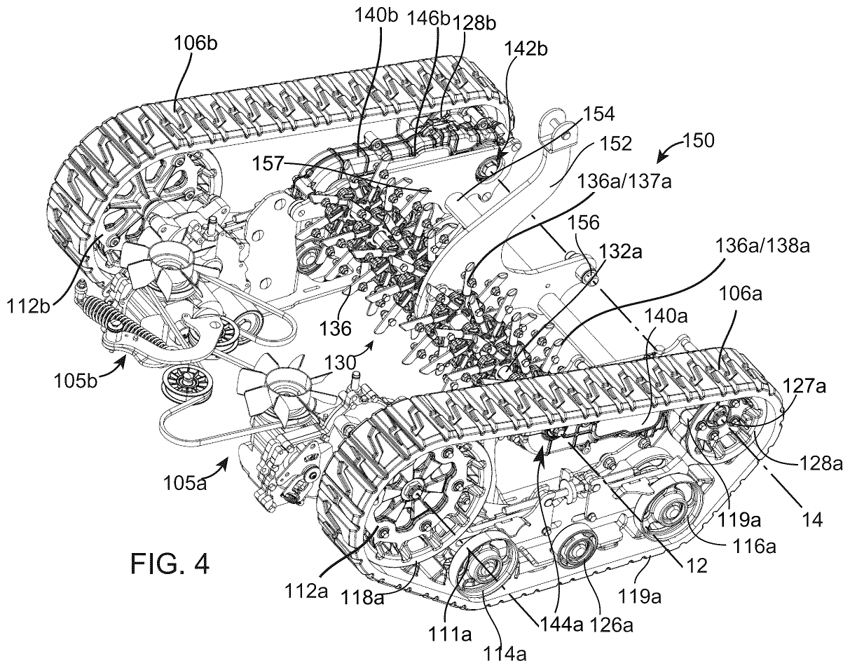

The drive sprockets 112a, 112b can generally be powered through various types of drive systems and combinations of drive systems known in the art. In the current example, visible in FIG. 4 which is a simplified perspective view of a portion of a vehicle 100 consistent with FIGS. 1-3, each drive sprocket 112 is powered by its own unitized transaxle 105, each including its own hydrostatic pump, motor, and associated gearing. The transaxles 105 may be supported by the chassis 102 and powered by the prime mover 104 (e.g., via a drive belt pulley). While not illustrated, other drive systems, e.g., gear, chain, or pulley driven systems, pumps and motors, etc. may also be utilized without departing from the scope of the disclosure. As another example, a direct electric motor can be configured to power each drive sprocket 112.

Returning back to FIGS. 1-3, the first bogey wheel 114 and the second bogey wheel 116 are each rotatable relative to the chassis 102. The first bogey wheel 114 and the second bogey wheel 116 are generally configured to provide structural support the track 106. The bogey wheels 114, 116 may be freely rotatable relative to the chassis 102. In the current example, the first bogey wheel 114 and the second bogey wheel 116 generally have the same size and configuration. In various embodiments, the first bogey wheel 114 and the second bogey wheel 116 are aligned in the vertical direction, meaning that the first bogey wheel 114 and the second bogey wheel 116 are equally spaced from a horizontal ground surface 10. In various embodiments, the first bogey wheel 114 and the second bogey wheel 116 are also aligned in the lateral direction.

In some embodiments the track 106 is positioned directly between the first bogey wheel 114 and the ground surface 10 and the track 106 is positioned directly between the second bogey wheel 116 and the ground surface 10. In various embodiments, the portion of the track 106 extending longitudinally between the first bogey wheel 114 and the second bogey wheel 116 is a ground-contact section 119 of the track 106, which is configured to come into direct contact with the ground surface 10. The ground-contact section 119 can be generally planar in shape, where “generally planar” is used to refer to the general extension of the ground-contact section 119 and ignores surface irregularities along the track 106 such as treads.

The first bogey wheel 114 and the second bogey wheel 116 are generally spaced in the longitudinal direction. The bogey wheels 114, 116 are generally configured to maintain the track 106 under tension. In various embodiments the relative positions of the bogey wheels 114, 116 are adjustable to adjust the tension of the track 106. In the current example, the tensioner bar 120 is configured to adjust the relative positions of the bogey wheels 114, 116. The tensioner bar 120 generally has a mounting surface 122, a first end 121 that is longitudinally outward from the mounting surface 122, and a second end 123 that is longitudinally outward from the mounting surface 122. The first end 121 and the second end 123 extend in opposite longitudinal directions from the mounting surface 122. The mounting surface 122 is generally fixed relative to the chassis 102. The first end 121 and the second end 123 of the tensioner bar 120 are longitudinally translatable relative to the mounting surface 122. The first bogey wheel 114 is rotatably coupled to the first end 121 of the tensioner bar 120 and the second bogey wheel 116 is rotatably coupled to the second end 123 of the tensioner bar 120.

In some embodiments, the tensioner bar 120 is configured to translate the first end 121 and the second end 123 and, therefore, the first bogey wheel 114 and the second bogey wheel 116, equally in opposite longitudinal directions. Such a configuration may advantageously maintain the location of the center of gravity of the vehicle 100 regardless of the specific tensioner bar setting. The tensioner bar 120 generally has an adjustment interface 124 (best visible in FIG. 3) that is in communication with the first end 121 and the second end 123. In some embodiments the adjustment interface 124 is a manually adjustable feature, such a rotatable dial, knob, or handle. In some such embodiments the first end 121 and the second end 123 are threaded to the mounting surface 122, and rotation of the adjustment interface 124 translates the first end 121 and the second end 123 along the threads. Other configurations are certainly contemplated, however.

For example, in some other embodiments the adjustment interface 124 is configured to provide incremental translation of the first end 121 and the second end 123 relative to the mounting surface 122. For example, alignment features such as pin holes or notches can be used between the end 121, 123 and the mounting surface 122 in combination with a securing mechanism such as a pin or a bracket to secure the end 121, 123 relative to the mounting surface 122 at the selected position. Such a configuration may employ a spring or other linkage to provide the user with a mechanical advantage, particularly when separating the first end 121 and the second end 123. In some embodiments the adjustment interface 124 can include electro-mechanical components such as a button which, when engaged by a user, sends an electrical signal to initiate translation of the first end 121 and the second end 123.

In some embodiments, the first end 121 and the second end 123 of the tensioner bar 120 are not vertically or laterally translatable relative to the chassis 102. Such a configuration may advantageously maintain the alignment of the first bogey wheel 114 and the second bogey wheel 116 in the vertical and lateral directions, and/or maintain the center of gravity of the vehicle in the vertical and/or lateral directions.

In some embodiments, including the one depicted, a third bogey wheel 126 is rotatably fixed to the chassis 102. The track 106 is further disposed around the third bogey wheel 126. The third bogey wheel 126 is central to the first bogey 114 wheel and the second bogey wheel 116. In various embodiments, the first bogey wheel 114 and second bogey wheel 116 are equally spaced from the third bogey wheel 126. Such a configuration may advantageously increase the rigidity of the track 106. In the current example, the track 106 is directly between the third bogey wheel 126 and the ground surface 10. The first bogey wheel 114, the second bogey wheel 116, and the third bogey wheel 126 define a horizontal plane that the track 106 extends across. In various embodiments, the rotational axis of the third bogey wheel is substantially aligned in the longitudinal direction with the center of the ground-contact section of the track, where “substantially aligned” means within 2%, 1%, or 0.5% of the distance to the longitudinal center of the ground-contact section.

It will be appreciated that the track 106 can be disposed around bogey wheels in addition to the first, second, and third bogey wheels 114, 116, 126. Further, in some embodiments the third bogey wheel 126 can be omitted. In yet other embodiments the third bogey wheel 126 can be positioned in a different location rather than longitudinally between the first bogey wheel 114 and the second bogey wheel 116.

Some embodiments of the present technology relate to a vehicle 100 that is, in particular, a grounds maintenance vehicle, where an implement 130, which is coupled to the chassis 102, is configured to be driven by the track assembly 110. The implement 130 is obstructed from view in FIGS. 1-3, but an example implement 130 is visible in FIG. 4, which is a partial view of an example vehicle consistent with FIGS. 1-3. The term “implement” is used to mean a tool that is configured to perform a maintenance task on or around the ground surface 10. In the current example, the implement 130 includes aerating tines 136 that are rotatably coupled to the chassis 102. The particular variety of implement is not generally limited but may be an implement 130 that is driven through the application of torque. Other example implements include sweeper brushes, slicer blades, mowers, a tiller tines, plow blades, dethatcher tines, and the like. In some embodiments the implement 130 has a drive input that is rotatable around a lateral axis 12. In some embodiments the implement 130 itself has a lateral axis of rotation 12.

In some embodiments where the vehicle 100 has an implement 130, the track assembly 110 is configured to drive the implement 130 via a driven sprocket 128 and a mechanical communication assembly 140 extending from the driven sprocket 128 to the implement 130. The driven sprocket 128 is generally rotatable relative to the chassis 102. The driven sprocket 128 can have a driven sprocket rotational axis 127. The track 106 is disposed around the drive sprocket 112 and the driven sprocket 128 and is in mechanical communication with both the drive sprocket 112 and the driven sprocket 128. In particular, the track 106 is configured to be driven by the drive sprocket 112 and the track 106 is configured to drive the driven sprocket 128. Similar to the drive sprocket 112, the driven sprocket 128 is configured to mutually engage with the track 106 to facilitate force transmission from the track 106 to the driven sprocket 128. In the current example, the teeth 118 of the track 106 are configured to engage corresponding lugs 129 of the driven sprocket 128. In embodiments where the track assembly 100 has bogey wheels, discussed above, the track 106 is also disposed around the bogey wheels, although it should be noted that bogey wheels, including configurations discussed above, are not necessary to all embodiments. Similarly, in various embodiments a tensioner bar (120) need not be present or be consistent with the specific example configurations discussed above.

The mechanical communication assembly 140 is configured to be in operative communication with the implement 130. In various embodiments, the mechanical communication assembly 140 is configured to selectively transmit torque from the driven sprocket 128 (which is transmitted from the track 106) to the drive input of the implement 130. The mechanical communication assembly 140 can have a variety of different configurations. In some examples the mechanical communication assembly 140 is a belt, such as a timing belt. In some examples the mechanical communication assembly 140 is a gear box. In some examples the mechanical communication assembly 140 is a chain drive.

The mechanical communication assembly 140 has an assembly input 142 that is driven by the driven sprocket 128 such that rotation of the driven sprocket 128 results in rotation of the assembly input 142. The assembly input 142 is in operable communication with the assembly output 144 via belts, chains, gears, and the like.

In some embodiments the implement 130 has an implement drive shaft 132 in operable communication with a tool portion 134 of the implement 130. The assembly output 144 is configured to be in operable communication with the implement drive shaft 132. In various embodiments, the tool portion 134 of the implement 130 has a lateral line of action 12, which is an imaginary line extending perpendicularly to the longitudinal direction across the longitudinal center of the tool portion 134 of the implement 130. In some embodiments the lateral line of action 12 of the implement 130 is a lateral axis of rotation 12. In the current example, the implement drive shaft 132 can be configured to rotate around the lateral line of action 12. Here the aerating tines 136 are configured to rotate around the lateral line of action 12. In some embodiments the tool portion 134 is configured to rotate around the lateral line of action 12 during operation.

It is noted that, in some examples, the tool portion 134 can include a driven portion (here, driven tines 138) that are configured to be driven by the implement drive shaft 132. The tool portion 134 may also include an idle portion (here, idler tines 137) that operate independently of the implement drive shaft 132. The idle portion may operate in response to the propulsion of the vehicle 100 across the ground surface. In the current example, the driven tines 138 are disposed outwardly towards the sides of the vehicle and the idler tines 137 are disposed centrally towards the lateral center of the vehicle 100. Such a configuration may allow different portions of the tool portion 134 to traverse the ground surface at different rates, which may advantageously prevent the tool portion from tearing the ground surface such as when the vehicle is turning. In various examples, the mechanical communication assembly is configured to be tuned to match the rotation of the driven tines 138 with the speed of the track 106 across the ground surface.

In some embodiments, the tool portion of the implement is not rotatably coupled to the vehicle. For example, the tool portion of the implement can have reciprocating components, such as one or more reciprocating tines, blades, brushes, and the like. In such examples, the lateral line of action 12 does not define an axis of rotation of the implement tool.

In a variety of embodiments the lateral line of action 12 of the implement 130 is positioned centrally relative to the longitudinal center of gravity of the vehicle 100, which is best visible in FIG. 3. In some embodiments, the lateral line of action 12 of the tool portion 134 is central to the ground-contact section 119 relative to the longitudinal direction (best visible in FIG. 3). By “central” to the ground-contact section relative to the longitudinal direction it is meant that the lateral line of action is within 10%, 9%, 8%, 7%, or 6% of the distance to the longitudinal center c of the ground-contact section. In some embodiments, the lateral line of action is within 2 inches (5.1 cm) or even within 1 inch (2.5 cm) of the longitudinal center of the ground-contact section.

In some embodiments, the lateral line of action 12 of the implement 130 can be repositionable relative to the vehicle 100 within a repositioning range. In many such embodiments, the lateral line of action 12 of the tool portion 134 is central to the ground-contact section of the track 106 in the longitudinal direction through the repositioning range of the tool portion 134.

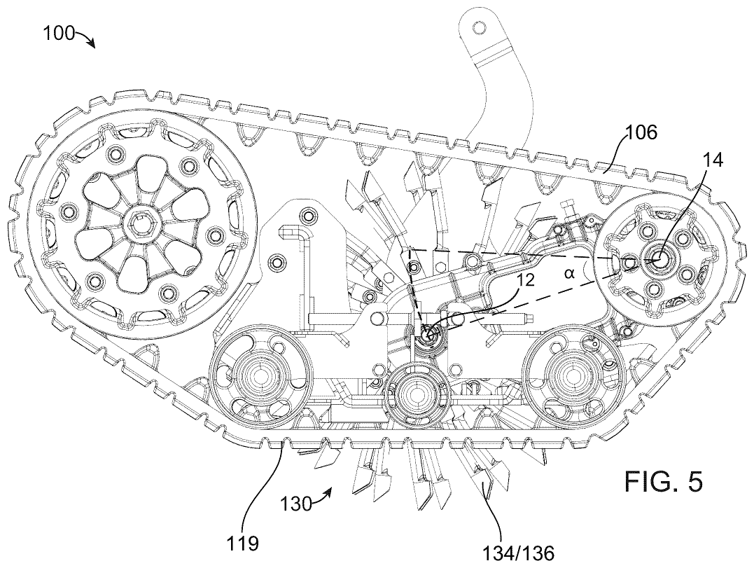

In some examples, the implement 130 is pivotably coupled to the vehicle 100. In some such examples, the implement 130 has a lateral pivot axis 14 (best visible in FIG. 4) about which the implement 130 is configured to pivot. The pivot axis 14 can define the repositioning range of implement 130. For example, the lateral line of action 12 of the implement 130 can be configured to pivot about the lateral pivot axis 14. In examples consistent with the current embodiment, the current example, the implement 130 can have a retracted position and an expanded position. The implement 130 has a repositioning range a that is around the pivot axis 14 from the retracted position to the expanded position. FIGS. 1-4 shows the implement 130 in a retracted position. In some embodiments the retracted position eliminates contact between the implement 130 and the ground surface 10. In some embodiments, the implement 130 makes contact with the ground surface 10 in the expanded position. FIG. 5, which is a simplified side view of the track assembly 110 and the implement 130, depicts the implement 130 in an expanded position relative to the vehicle 100, which can be compared to FIG. 3 that is a view of the vehicle 100 from the same side with the implement (not visible) in a retracted position. FIG. 5 shows an example repositioning range α of the implement 130.

In the current example, the lateral line of action 12 of the aerating tines 136 are configured to pivot about the lateral pivot axis 14. The aerating tines 136 may pivot downwardly relative to the vehicle 100 about the pivot axis 14 to penetrate the ground surface 10 in its expanded position. In some embodiments the penetration depth may be selected by a user, which may define the particular pivot angle within the repositioning range a of the aerating tines 136 from the retracted position to the expanded position.

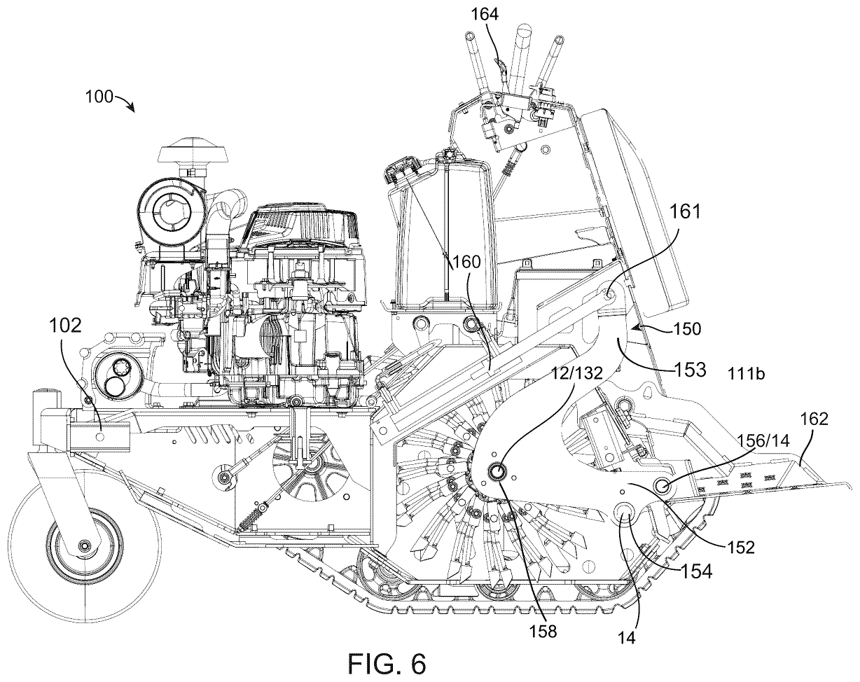

Various configurations that allow repositioning of the implement 130 relative to the vehicle 100 are contemplated. One particular configuration will now be described with reference to FIG. 4 and FIG. 6, where FIG. 6 is a cross-sectional view of the example vehicle 100 consistent with FIGS. 1-5 through a longitudinal and vertical plane. A pivot assembly 150 is pivotably coupled to the chassis 102 and rigidly coupled to the implement 130. The pivot assembly 150 has a pivot hinge 156 that defines the pivot axis 14 of the implement 130. In the current example, the pivot hinge 156 aligns in the lateral direction with the driven sprockets 128a, 128b on each side of the vehicle 100. In various examples, including that depicted, the lateral pivot axis 14 and the driven sprocket rotational axis 127 (FIG. 4) are parallel. In some such examples, lateral pivot axis 14 and the driven sprocket rotational axis 127 are collinear.

In the current example, the pivot assembly 150 includes a swing arm 152 and a lateral rod 154. The lateral rod 154 is rigidly coupled to the swing arm 152. In some embodiments, the swing arm 152 is positioned centrally to the lateral width of the vehicle 100. The lateral rod 154 extends across the lateral width of the vehicle 100. The swing arm 152 has the pivot hinge 156 that is pivotably coupled to the chassis 102. Longitudinally outward from the pivot hinge 156, the swing arm 152 is rigidly coupled to the lateral rod 154 such that pivoting of the swing arm 152 about the pivot axis 14 results in pivoting of the lateral rod 154 about the pivot axis 14. Longitudinally outward from the pivot hinge 156 is an implement connector 158 (visible in FIG. 6) that is coupled to the implement 130. In this particular example, the implement connector 158 is coupled to an implement shaft 132, such as an implement drive shaft, which defines the lateral line of action 12 about which the implement 130 is configured to rotate. Pivoting of the swing arm 152 about the pivot axis 14 results in pivoting of the implement shaft 132 about the pivot axis 14.

The implement 130 may be pivoted between a retracted position and an expanded position (which may include any one of a plurality of operating positions) via an actuator 160 such as a linear actuator as depicted in FIG. 6. The implement 130 can be pivoted between the retracted position and the expanded position by a user manipulating an actuator interface 164 on or near an operator position, such as a standing platform 162, a seat, or a walk-behind area. The actuator interface can be a foot pedal, manually engageable handle, button, lever, representation of a button on a touch screen, or the like, that is configured to operate the linear actuator 160 based on user manipulation of the actuator interface. As the actuator length shortens (i.e., as the rod retracts), the implement 130 pivots downwardly relative to the chassis 102 about the transverse pivot axis 14, such that the implement 130 moves downwardly along the arc shown in FIG. 5. As the actuator length lengthens (i.e., as the rod expands), the implement 130 pivots upwardly relative to the chassis 102 about the transverse pivot axis 14, such that the implement 130 moves upwardly along the arc shown in FIG. 5.

In the current example, the swing arm 152 has a control extension 153 extending outwardly from the pivot axis 14. The control extension 153 is coupled to a distal end 161 of the linear actuator 160. Retraction and extension of the linear actuator 160 results in pivoting of the swing arm 152 about the pivot axis 14.

In the current example, the pivot assembly 150 is also rigidly coupled to at least a portion of the mechanical communication assembly 140. As such, the mechanical communication assembly 140 is pivotably coupled to the chassis 102. Each end of the lateral rod 154 is fixed to a mechanical communication assembly 140 on each side of the vehicle 100 (see FIG. 4, which particularly shows the connection between the lateral rod and the second mechanical communication assembly 140b). In this particular example, each end of the lateral rod 154 is coupled to a housing 146 of the mechanical communication assembly 140 via a coupling plate 157. The coupling plate 157 is rigidly coupled to the lateral rod 154 and the housing 146 of the mechanical communication assembly 140.

As discussed above, the mechanical communication assembly 140 has an assembly output 144 operably coupled to the implement drive shaft 132. The mechanical communication assembly 140 can be fixed relative to the implement drive shaft 132 such that pivoting of the swing arm 152 and the implement drive shaft 132 about the pivot axis equally pivots the mechanical communication assembly 140 about the pivot axis 14.

As mentioned above, other configurations that allow repositioning of the implement relative to the vehicle are contemplated. For example, in some embodiments the implement is linearly translated relative to the vehicle, such as vertically (up and down) and longitudinally (front and back).

It will be appreciated that vehicles 100 consistent with the technology disclosed herein can have various different configurations. In currently depicted embodiments, a first handle 182 and a second handle 184 extend outward from the chassis 102 and are each configured to be manually translated relative to the chassis 102 to control operation of the vehicle 100. In the example depicted, the first handle 182 and the second handle 184 are each manually pivotable about a pivot. The first handle 182 has a first pivot 183 (best visible in FIG. 3) and the second handle 184 has a second pivot 185 (visible in FIG. 2). The first handle 182 and the second handle 184 are manually translated about their respective pivots 183, 185 to control operation of the vehicle 100.

In some embodiments, the first handle 182 and second handle 184 can be considered a twin lever control panel, where translation of each handle 182, 184 controls the speed and rotational direction of a corresponding track assembly 110a, 110b. In this example, translation of the first handle 182 controls the first track assembly 110a and translation of the second handle 184 controls the second track assembly 110b. A track assembly 110 is considered to “correspond” to a particular handle when it is located on the same side of the vehicle 100, such that a track assembly on the right side of the vehicle corresponds to a handle on the right side of the vehicle.

The vehicle 100 can have handles with alternative configurations. In some embodiments, the handles can be configured as a steering wheel. The vehicle 100 can have various alternative and additional controls that can be used by the operator to manipulate function of the vehicle 100. The one or more handles 182, 184 and/or various other controls of the control station 180 are configured to be accessible to the operator positioned on the vehicle 100.

In the current example, the vehicle 100 is configured as a stand-on vehicle. As such, a standing platform 170 (FIGS. 2 and 3) is coupled to the chassis 102. The standing platform 170 is one or more surface(s) adapted to support the feet of a standing operator. The standing platform 170 is coupled to the chassis 102 towards the second end 103. A support pad 172 can be coupled to the vehicle 100 that is configured to support the body of standing operator positioned on the standing platform 170. In alternative embodiments, the vehicle can be a riding vehicle or a walk-behind vehicle. In some other embodiments, the vehicle has a seat to accommodate a seated operator instead of a standing operator. In embodiments where the vehicle has a seat instead of a standing platform, the one or more handles 182, 184 and other system controls are configured to be accessible to the seated operator.

As is best visible in FIG. 1, the current example vehicle 100 has a pair of front ground engaging wheels 108 (e.g., left and right caster wheels 108a, 108b) may attach to forwardly extending rails of the chassis 102 and support the front of the vehicle 100 in rolling engagement with the ground surface 10. Although the illustrated vehicle 100 has the track assembly 110 towards the rear of the vehicle and caster wheels 108 towards the front, this configuration is not limiting. For example, other embodiments may reverse the location of the wheels, e.g., caster wheels towards the rear and the track towards the front. Moreover, other configurations may omit caster wheels altogether.

### EXEMPLARY ASPECTS

Aspect 1. A grounds maintenance vehicle comprising:
a chassis;
a track assembly comprising:
   a drive sprocket rotatable relative to the chassis;
   a driven sprocket rotatable relative to the chassis; and
   a track disposed around the drive sprocket and the driven sprocket, wherein the track is in mechanical communication with the drive sprocket and the driven sprocket and the track is configured to contact a ground surface;
an implement coupled to the chassis; and
a mechanical communication assembly in operative communication with the implement, wherein the mechanical communication assembly extends from the driven sprocket to the implement.

Aspect 2. The grounds maintenance vehicle of any one of Aspects 1 and 2-18, wherein the mechanical communication assembly comprises a belt.

Aspect 3. The grounds maintenance vehicle of any one of Aspects 1-2 and 4-18, wherein the mechanical communication assembly comprises a gear box.

Aspect 4. The grounds maintenance vehicle of any one of Aspects 1-3 and 5-18, wherein the mechanical communication assembly comprises a chain drive.

Aspect 5. The grounds maintenance vehicle of any one of Aspects 1-4 and 6-18, wherein the implement comprises aerating tines coupled to the chassis.

Aspect 6. The grounds maintenance vehicle of any one of Aspects 1-5 and 7-18, wherein the implement has a lateral line of action.

Aspect 7. The grounds maintenance vehicle of any one of Aspects 1-6 and 8-18, wherein the track has a ground-contact section extending longitudinally, and the lateral line of action is central to the ground-contact section in the longitudinal direction.

Aspect 8. The grounds maintenance vehicle of any one of Aspects 1-7 and 9-18, wherein the lateral line of action of the implement is repositionable and has repositioning range, wherein the lateral line of action of the implement is central to the ground-contact section in the longitudinal direction through the repositioning range.

Aspect 9. The grounds maintenance vehicle of any one of Aspects 1-8 and 10-18, wherein the lateral line of action is a lateral pivot axis and the repositioning range is a pivot range about the lateral pivot axis.

Aspect 10. The grounds maintenance vehicle of any one of Aspects 1-9 and 11-18, further comprising:
a first bogey wheel rotatable relative to the chassis; and
a second bogey wheel rotatable relative to the chassis, wherein the first bogey wheel and the second bogey wheel are longitudinally spaced, wherein the track is further disposed around the first bogey wheel and the second bogey wheel.

Aspect 11. The grounds maintenance vehicle of any one of Aspects 1-10 and 12-18, further comprising a tensioner bar having a mounting surface, a first end extending longitudinally outward from the mounting surface, and a second end extending longitudinally outward from the mounting surface, wherein the first end and the second end are longitudinally translatable relative to the mounting surface, the mounting surface is fixed to the chassis, the first bogey wheel is rotatably coupled to the first end and the second bogey wheel is rotatably coupled to the second end.

Aspect 12. The grounds maintenance vehicle of any one of Aspects 1-11 and 13-18, wherein the first bogey wheel and the second bogey wheel are aligned in the vertical direction.

Aspect 13. The grounds maintenance vehicle of any one of Aspects 1-12 and 14-18, wherein the track has a ground-contact section extending longitudinally from the first bogey wheel to the second bogey wheel.

Aspect 14. The grounds maintenance vehicle of any one of Aspects 1-13 and 15-18, wherein the first end and the second end of the tensioner bar are not vertically or laterally translatable relative to the chassis.

Aspect 15. The grounds maintenance vehicle of any one of Aspects 1-14 and 16-18, wherein the tensioner bar comprises an adjustment interface in communication with the first end and the second end, wherein the adjustment interface is configured to translate the first end and the second end equally in opposite longitudinal directions.

Aspect 16. The grounds maintenance vehicle of any one of Aspects 1-15 and 17-18, wherein the adjustment interface is rotatable relative to the mounting surface.

Aspect 17. The grounds maintenance vehicle of any one of Aspects 1-16 and 18, further comprising a third bogey wheel rotatably fixed to the chassis, the third bogey wheel being central to the first bogey wheel and the second bogey wheel, wherein the first bogey wheel and second bogey wheel are equally spaced from the third bogey wheel.

Aspect 18. The grounds maintenance vehicle of any one of Aspects 1-17, wherein the first bogey wheel, the second bogey wheel, and the third bogey wheel define a horizontal plane that the track extends across.

Aspect 19. A grounds maintenance vehicle comprising:
a chassis;
a track assembly comprising:
   a drive sprocket rotatable relative to the chassis;
   a first bogey wheel rotatable relative to the chassis; and
   a track disposed around the drive sprocket and the first bogey wheel, wherein the track is in mechanical communication with the drive sprocket and the first bogey wheel and the track has a ground-contact section extending longitudinally; and
an implement coupled to the chassis, wherein the implement has a lateral line of action that is central to the ground-contact section in the longitudinal direction.

Aspect 20. The grounds maintenance vehicle of any one of Aspects 19 and 21-37, wherein the lateral line of action of the implement is repositionable and has a repositioning range, wherein the lateral line of action of the implement is central to the ground-contact section in the longitudinal direction through the repositioning range.

Aspect 21. The grounds maintenance vehicle of any one of Aspects 19-20 and 22-37, further comprising a driven sprocket rotatable relative to the chassis, wherein the track is in mechanical communication with the driven sprocket.

Aspect 22. The grounds maintenance vehicle of any one of Aspects 19-21 and 23-37, wherein the lateral line of action is a lateral pivot axis and the repositioning range is a pivot range about the lateral pivot axis.

Aspect 23. The grounds maintenance vehicle of any one of Aspects 19-22 and 24-37, wherein the driven sprocket has a driven sprocket rotational axis, wherein the lateral pivot axis and the driven sprocket rotational axis are collinear.

Aspect 24. The grounds maintenance vehicle of any one of Aspects 19-23 and 25-37, further comprising a mechanical communication assembly in operative communication with the implement, wherein the mechanical communication assembly extends from the driven sprocket to the implement.

Aspect 25. The grounds maintenance vehicle of any one of Aspects 19-24 and 26-37, wherein the mechanical communication assembly comprises a gear box.

Aspect 26. The grounds maintenance vehicle of any one of Aspects 19-25 and 27-37, wherein the mechanical communication assembly comprises a timing belt.

Aspect 27. The grounds maintenance vehicle of any one of Aspects 19-26 and 28-37, wherein the mechanical communication assembly comprises a chain drive.

Aspect 28. The grounds maintenance vehicle of any one of Aspects 19-27 and 29-37, wherein the implement comprises aerating tines.

Aspect 29. The grounds maintenance vehicle of any one of Aspects 19-28 and 30-37, further comprising a second bogey wheel rotatable relative to the chassis, wherein the first bogey wheel and the second bogey wheel are longitudinally spaced and the track is further disposed around the second bogey wheel.

Aspect 30. The grounds maintenance vehicle of any one of Aspects 19-29 and 31-37, wherein the ground-contact section is defined from the first bogey wheel to the second bogey wheel.

Aspect 31. The grounds maintenance vehicle of any one of Aspects 19-30 and 32-37, further comprising a tensioner bar having a mounting surface, a first end extending longitudinally outward from the mounting surface, and a second end extending longitudinally outward from the mounting surface, wherein the first end and the second end are longitudinally translatable relative to the mounting surface, the mounting surface is fixed to the chassis, the first bogey wheel is rotatably coupled to the first end and the second bogey wheel is rotatably coupled to the second end.

Aspect 32. The grounds maintenance vehicle of any one of Aspects 19-31 and 33-37, wherein the first bogey wheel and the second bogey wheel are aligned in the vertical direction.

Aspect 33. The grounds maintenance vehicle of any one of Aspects 19-32 and 34-37, wherein the first end and the second end of the tensioner bar are not vertically or laterally translatable relative to the chassis.

Aspect 34. The grounds maintenance vehicle of any one of Aspects 19-33 and 35-37, wherein the tensioner bar comprises an adjustment interface in communication with the first end and the second end, wherein the adjustment interface is configured to translate the first end and the second end equally in opposite longitudinal directions.

Aspect 35. The grounds maintenance vehicle of any one of Aspects 19-34 and 36-37, wherein the adjustment interface is rotatable relative to the mounting surface.

Aspect 36. The grounds maintenance vehicle of any one of Aspects 19-35 and 37, further comprising a third bogey wheel rotatably fixed to the chassis, the third bogey wheel being central to the first bogey wheel and the second bogey wheel, wherein the first bogey wheel and second bogey wheel are equally spaced from the third bogey wheel.

Aspect 37. The grounds maintenance vehicle of any one of Aspects 19-36, wherein the first bogey wheel, the second bogey wheel, and the third bogey wheel define a horizontal plane that the track extends across.

Aspect 38. A grounds maintenance vehicle comprising:
a chassis; and
a ground-contacting track assembly disposed between a ground surface and the chassis comprising:
   a drive sprocket rotatable relative to the chassis;
   a first bogey wheel rotatable relative to the chassis;
   a second bogey wheel rotatable relative to the chassis, wherein the first bogey wheel and the second bogey wheel are longitudinally spaced;
   a track disposed around the drive sprocket, the first bogey wheel, and the second bogey wheel; and
   a tensioner bar having a mounting surface, a first end extending longitudinally outward from the mounting surface, and a second end extending longitudinally outward from the mounting surface, wherein the first end and the second end are longitudinally translatable relative to the mounting surface, the mounting surface is fixed to the chassis, the first bogey wheel is rotatably coupled to the first end and the second bogey wheel is rotatably coupled to the second end.

Aspect 39. The grounds maintenance vehicle of any one of Aspects 38 and 40-51, wherein the first bogey wheel and the second bogey wheel are aligned in the vertical direction.

Aspect 40. The grounds maintenance vehicle of any one of Aspects 38-40 and 41-51, further comprising a driven sprocket rotatable relative to the chassis, wherein the track is disposed around the driven sprocket.

Aspect 41. The grounds maintenance vehicle of any one of Aspects 38-41 and 42-51, wherein the track has a ground-contact section extending longitudinally from the first bogey wheel to the second bogey wheel.

Aspect 42. The grounds maintenance vehicle of any one of Aspects 38-39 and 43-51, wherein the first end and the second end of the tensioner bar are not vertically or laterally translatable relative to the chassis.

Aspect 43. The grounds maintenance vehicle of any one of Aspects 38-42 and 44-51, wherein the tensioner bar comprises an adjustment interface in communication with the first end and the second end, wherein the adjustment interface is configured to translate the first end and the second end equally in opposite longitudinal directions.

Aspect 44. The grounds maintenance vehicle of any one of Aspects 38-43 and 45-51, wherein the adjustment interface is rotatable relative to the mounting surface.

Aspect 45. The grounds maintenance vehicle of any one of Aspects 38-44 and 46-51, further comprising a third bogey wheel rotatably fixed to the chassis, the third bogey wheel being central to the first bogey wheel and the second bogey wheel, wherein the first bogey wheel and second bogey wheel are equally spaced from the third bogey wheel.

Aspect 46. The grounds maintenance vehicle of any one of Aspects 38-45 and 47-51, wherein the first bogey wheel, the second bogey wheel, and the third bogey wheel define a horizontal plane that the track extends across.

Aspect 47. The grounds maintenance vehicle of any one of Aspects 38-46 and 48-51, further comprising an implement rotatably coupled to the chassis.

Aspect 48. The grounds maintenance vehicle of any one of Aspects 38-47 and 49-51, wherein the track has a ground-contact section, and the implement has a lateral line of action that is central to the ground-contact section in the longitudinal direction.

Aspect 49. The grounds maintenance vehicle of any one of Aspects 38-48 and 50-51, wherein the lateral line of action of the implement is repositionable and has a repositioning range, and wherein the lateral line of axis of the implement is central to the ground-contact section in the longitudinal direction through the repositioning range.

Aspect 50. The grounds maintenance vehicle of any one of Aspects 38-49 and 51, wherein the lateral line of action is a lateral pivot axis and the repositioning range is a pivot range about the lateral pivot axis.

Aspect 51. The grounds maintenance vehicle of any one of Aspects 38-50, further comprising:
a driven sprocket rotatable relative to the chassis, wherein the track is in mechanical communication with the driven sprocket; and
a mechanical communication assembly in operative communication with the implement, wherein the mechanical communication assembly extends from the driven sprocket to the implement.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

The term “about” as used herein can allow for a degree of variability in a value or range, for example, within 10%, within 5%, or within 1% of a stated value or of a stated limit of a range and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A grounds maintenance vehicle comprising:
a chassis;
a track assembly comprising:
a drive sprocket rotatable relative to the chassis;
a driven sprocket rotatable relative to the chassis; and
a track disposed around the drive sprocket and the driven sprocket, wherein the track is in mechanical communication with the drive sprocket and the driven sprocket and the track is configured to contact a ground surface;
an implement coupled to the chassis; and
a mechanical communication assembly in operative communication with the implement, wherein the mechanical communication assembly extends from the driven sprocket to the implement.

2. The grounds maintenance vehicle of claim 1, further comprising:
a first bogey wheel rotatable relative to the chassis; and
a second bogey wheel rotatable relative to the chassis, wherein the first bogey wheel and the second bogey wheel are longitudinally spaced, wherein the track is further disposed around the first bogey wheel and the second bogey wheel.

3. The grounds maintenance vehicle of claim 2, further comprising a tensioner bar having a mounting surface, a first end extending longitudinally outward from the mounting surface, and a second end extending longitudinally outward from the mounting surface, wherein the first end and the second end are longitudinally translatable relative to the mounting surface, the mounting surface is fixed to the chassis, the first bogey wheel is rotatably coupled to the first end and the second bogey wheel is rotatably coupled to the second end.

4. The grounds maintenance vehicle of claim 2, wherein the first bogey wheel and the second bogey wheel are aligned in the vertical direction.

5. The grounds maintenance vehicle of claim 2, wherein the track has a ground-contact section extending longitudinally from the first bogey wheel to the second bogey wheel.

6. A grounds maintenance vehicle comprising:
a chassis;
a track assembly comprising:
a drive sprocket rotatable relative to the chassis;
a first bogey wheel rotatable relative to the chassis; and
a track disposed around the drive sprocket and the first bogey wheel, wherein the track is in mechanical communication with the drive sprocket and the first bogey wheel and the track has a ground-contact section extending longitudinally; and
an implement coupled to the chassis, wherein the implement has a lateral line of action that is central to the ground-contact section in the longitudinal direction.

7. The grounds maintenance vehicle of claim 6, wherein the lateral line of action of the implement is repositionable and has a repositioning range, wherein the lateral line of action of the implement is central to the ground-contact section in the longitudinal direction through the repositioning range.

8. The grounds maintenance vehicle of claim 7, further comprising a driven sprocket rotatable relative to the chassis, wherein the track is in mechanical communication with the driven sprocket.

9. The grounds maintenance vehicle of claim 7, wherein the lateral line of action is a lateral pivot axis and the repositioning range is a pivot range about the lateral pivot axis.

10. The grounds maintenance vehicle of claim 9, wherein the driven sprocket has a driven sprocket rotational axis, wherein the lateral pivot axis and the driven sprocket rotational axis are collinear.

11. The grounds maintenance vehicle of claim 8, further comprising a mechanical communication assembly in operative communication with the implement, wherein the mechanical communication assembly extends from the driven sprocket to the implement.

12. A grounds maintenance vehicle comprising:
a chassis; and
a ground-contacting track assembly disposed between a ground surface and the chassis comprising:
a drive sprocket rotatable relative to the chassis;
a first bogey wheel rotatable relative to the chassis;
a second bogey wheel rotatable relative to the chassis, wherein the first bogey wheel and the second bogey wheel are longitudinally spaced;
a track disposed around the drive sprocket, the first bogey wheel, and the second bogey wheel; and
a tensioner bar having a mounting surface, a first end extending longitudinally outward from the mounting surface, and a second end extending longitudinally outward from the mounting surface, wherein the first end and the second end are longitudinally translatable relative to the mounting surface, the mounting surface is fixed to the chassis, the first bogey wheel is rotatably coupled to the first end and the second bogey wheel is rotatably coupled to the second end.

13. The grounds maintenance vehicle of claim 12, wherein the first bogey wheel and the second bogey wheel are aligned in the vertical direction.

14. The grounds maintenance vehicle of claim 12, further comprising a driven sprocket rotatable relative to the chassis, wherein the track is disposed around the driven sprocket.

15. The grounds maintenance vehicle of claim 12, wherein the track has a ground-contact section extending longitudinally from the first bogey wheel to the second bogey wheel.

16. The grounds maintenance vehicle of claim 12, wherein the first end and the second end of the tensioner bar are not vertically or laterally translatable relative to the chassis.

17. The grounds maintenance vehicle of claim 12, wherein the tensioner bar comprises an adjustment interface in communication with the first end and the second end, wherein the adjustment interface is configured to translate the first end and the second end equally in opposite longitudinal directions.

18. The grounds maintenance vehicle of claim 17, wherein the adjustment interface is rotatable relative to the mounting surface.

19. The grounds maintenance vehicle of claim 12, further comprising a third bogey wheel rotatably fixed to the chassis, the third bogey wheel being central to the first bogey wheel and the second bogey wheel, wherein the first bogey wheel and second bogey wheel are equally spaced from the third bogey wheel.

20. The grounds maintenance vehicle of claim 19, wherein the first bogey wheel, the second bogey wheel, and the third bogey wheel define a horizontal plane that the track extends across.
